(19) United States
(12) Patent Application Publication
(10) Pub. No.: US 2003/0045351 A1
(43) Pub. Date: Mar. 6, 2003

(54) Data transfer sequence in a gaming machine to provide increased security of data

(76) Inventor: Paul Gauselmann, Espelkamp (DE)

Correspondence Address: Brian D. Ogonowsky, Patent Law Group LLP, Suite 223, 2635 North First Street, San Jose, CA, 95134-2049, US

(21) Appl. No.: 10/199,337

(22) Filed: Jul. 19, 2002

(30) Foreign Application Priority Data
Aug. 30, 2001 (DE) 101 42 537.6

(51) Int. Cl. G06F 19/00

(52) U.S. Cl. 463/29

(57) ABSTRACT

A secure first memory contains a boot program and a decryption key. When the gaming device, such as a stand-alone slot machine, is switched on, the boot program is used to download a start program from an external memory into a main memory. The start program contains a decryption algorithm. The start program is then used to download an encrypted gaming program from the external memory. The start program decrypts the gaming program using the code key from the first memory and stores the decrypted gaming program in the main memory. A main processor then carries out the gaming program when a player initiates play of the gaming device. Because of the special sequence of all steps to load the data, an unauthorized person cannot load different or changed programs to any of the memories.

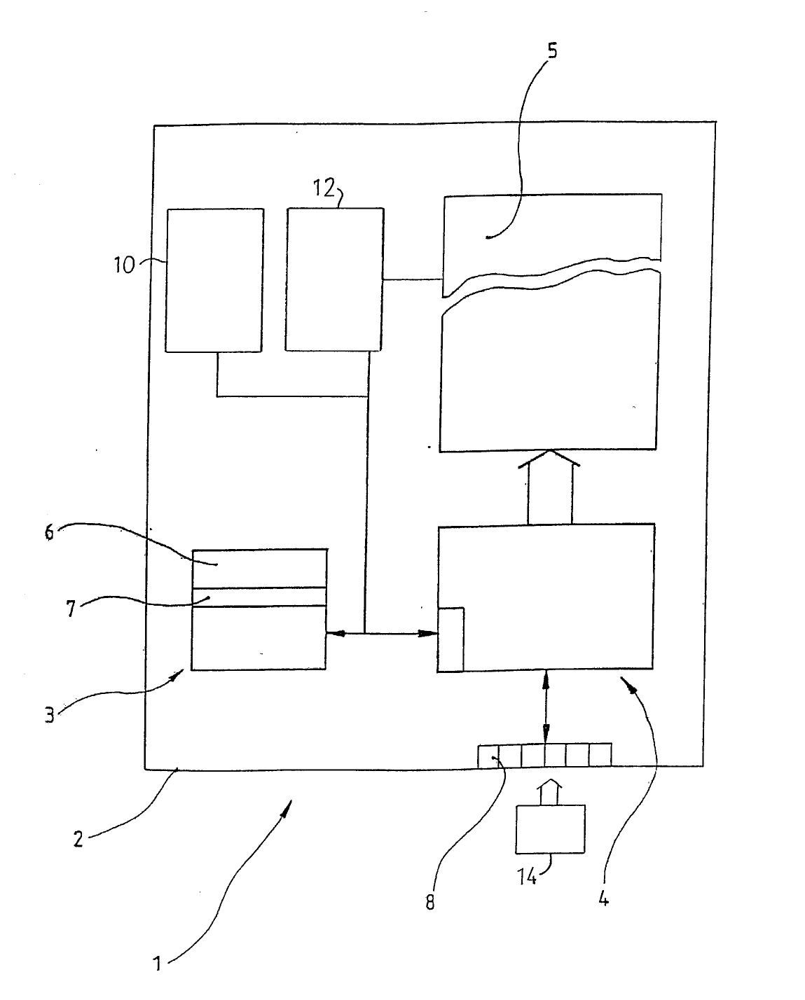

### FIELD OF INVENTION

The invention is related to a method to increase the security of data in a gaming machine.

### BACKGROUND

From the technical description of the gaming machine “Triomint Top-Spiel” by the company NSM, a control unit is known comprising a microprocessor with a memory, such as EAROM, EPROM, and/or RAM. The memory data is verified with a checksum.

If tampering of the processor or memory is detected, triggering a safeguard routine, all critical data in the memory is deleted, and the output of the processor is locked. The safeguard routine will be activated even if the memory is damaged.

Additionally the control unit comprises a self-diagnostic unit that is activated when the gaming machine is switched on. When the gaming machine is switched on, all serial input and output interfaces and the memory are checked by comparing the test results to a predetermined value. If the check results in a deviation from the predetermined value, the gaming machine will not be activated.

However, the check will be ineffective if the programs to calculate the checksum are not running. The check will also be ineffective if data is changed and the checksum of the changed data is identical to the predetermined checksum.

Thus, there exists a certain level of security in gaming machines that thwarts unauthorized attempts to affect the outcome of a game or the awards paid. However, increased security measures are desirable.

### SUMMARY

The structures and methods described herein effectively prevent an unauthorized person from tampering with a gaming program to affect the outcome of a game or to receive awards.

A non-volatile memory, such as a flash memory and/or an EEPROM, are controlled by a first microprocessor in the gaming device. The non-volatile memory has its contents secured with a lock bit to prevent the memory contents from being changed. The non-volatile memory contains a boot program and a decryption key.

When the gaming device, such as a stand-alone slot machine, is switched on, the boot program is used to download a start program from an external memory, such as a CD ROM. The term “external memory” refers to a memory that is typically not on the same circuit board as the microprocessors and other memories. The start program is downloaded into a main memory. The start program contains a decryption algorithm. The start program is then used to download an encrypted gaming program from the external memory. The start program decrypts the gaming program using the code key from the non-volatile memory and stores the decrypted gaming program in the main memory. A main processor then carries out the gaming program when a player initiates play of the gaming device.

The various programs are verified using a checksum or other verification technique for added security. Further, the memories and microprocessors are located in a secure housing such that a forcible opening of the housing causes all memory contents to be deleted.

Because of the special sequence of all steps to load the data, an unauthorized person cannot load different or changed programs to any of the memories. The special sequence of steps cannot be determined by an unauthorized person because forcibly opening the housing containing the memories and microprocessors causes all data in at least the main memory to be deleted.

### BRIEF DESCRIPTION OF THE DRAWING

The FIGURE depicts memories and microprocessors in a secure housing within a gaming device, where the microprocessors carry out the security methods described herein.

### DETAILED DESCRIPTION

An example of the present invention is described below. The invention is recited in the claims.

The FIGURE shows certain elements within a security module 2. The security module 2 comprises a bipartite housing. In the housing is a printed circuit board on which is mounted a microcontroller 3 with integrated memory 6,7, another microcontroller 4, at least one semiconductor main memory 5 communicating with microcontroller 4, sensors 10 that monitor the parameters of the housing environment (such as an opening of the housing), and a memory deletion circuit 12. For purposes of this disclosure, memories 6 and 7 will be considered a single memory.

The memory deletion circuit 12 performs a routine to delete the contents of the main memory 5 upon a signal from sensors 10 that there is tampering with module 2. The memory deletion circuit 12 and sensors 10 may use well known techniques. For example, if memory 5 requires a supply voltage to maintain its memory contents, the memory deletion circuit 12 may delete the memory contents by removing power from memory 5.

Sensors 10 may include any type of switches, fuses, thermosensors, voltage detectors, and other known sensors for detecting tampering with module 2. The various sensors 10 are located where appropriate for their function. Sensors 10 may monitor for mechanical, electrical, thermal, optical, and/or chemical attacks to module 2. Such attacks include manipulations of the operating voltage and the surrounding temperature. The memory deletion circuit 12 is activated if the monitored values are out of a predetermined range, causing the data in the main memory 5 to be deleted.

The main memory 5 is, in one embodiment, a battery supported static RAM memory. Other types of main memory may be used.

Microcontroller 3, such as a AT90S120, is used as a boot processor and uses an integrated flash memory 6 and EEPROM memory 7. It is not possible to read the data in memory 6 or 7 after the flash memory 6 is programmed and a lock-bit in memory 6 is set. A boot program is stored in the flash memory 6 to initialize and start microcontroller 4 (the main processor). Routines may also be stored in the EEPROM memory 7 as well. Also stored in the flash memory 6 is a code digit (a key) for a decryption algorithm.

Microcontroller 3 uses a lithium battery as a backup power supply, which ensures that the contents of memories 6, 7 remain secured in case of a power failure. Microcontroller 3 has a serial connection to microcontroller 4.

Microcontroller 4, such as a Motorola MC68331, is used as the main processor. Microcontroller 4 has a parallel connection to the main memory 5 and a serial connection to interface 8 for external connection. A conventional external memory 14 (e.g., a CD ROM drive with a CD ROM) can be connected to interface 8, and start-up and gaming application programs can be loaded from the external memory 14 via interface 8.

Assuming the gaming device (e.g., a video slot machine) has just been turned on (or upon initializing the gaming device), the following sequence takes place for downloading a gaming program from the external memory 14 to the main memory 5.

Microcontroller 3, using a program stored in memory 6 or 7, calculates a checksum from predetermined address locations in the main memory 5 and compares the calculated checksum to a predetermined checksum stored in memory 6 or 7. If the predetermined checksum is not found, microcontroller 3 determines that the boot program has not yet been downloaded into the main memory 5. Accordingly, microcontroller 3 then downloads the boot program from the flash memory 6 to the predetermined address locations in the main memory 5 using a Background Debug Mode (BDM) interface of microcontroller 4. BDM interfaces are well known.

After the boot program is transmitted to the main memory 5, it is checked by calculating the checksum and comparing it to the predetermined checksum. If there is no error in the transmission, microcontroller 3 initiates the boot program and, pursuant to the boot program, microcontroller 4 loads a start program from the external memory 14, via the serial interface 8, into the main memory 5.

The start program performs a checksum on the main memory 5 before initiating the downloading of the gaming program from the external memory 14.

The start program comprises decryption software for decrypting the encrypted gaming program in the external memory 14. The start program loads a code digit (a key) from the flash memory 6, via microcontroller 3, which is used as a key in the decryption algorithm to decrypt the gaming program. The start program then initiates downloading the encrypted gaming program from the external memory 14. The encrypted gaming program is decrypted on the fly using the decryption algorithm and the key.

After the gaming program has been downloaded to the main memory 5, microcontroller 3 uses the BDM interface of microcontroller 4 to check the contents of the main memory 5. A checksum of the predetermined address locations of the main memory 5 is calculated. This calculated checksum is compared to the predetermined checksum. If the two checksums match, microcontroller 3 performs a system reset to thereby cause microcontroller 4 to restart the start program. The start program checks the main memory 5 for the gaming program and, finding it there, initiates the gaming program.

The gaming program then carries out conventional gaming functions, such as determining if a player has bet credits, determining when the player has initiated play of the game, carrying out the game, and awarding credits upon a win. The game may be the display of rotating reels, where the random stopping of the reels results in a combination of symbols being displayed. Certain combinations of symbols award credits or coins to the player.

Thus, a sequence of steps has been disclosed that provides added security against an unauthorized person tampering with the gaming program or other software to win games or obtain an award. Multiple security techniques prevent a person from knowing the sequence of steps and from being able to operate a gaming program that has been tampered with.

Having described an embodiment of the invention in detail, those skilled in the art will appreciate that modifications may be made without departing from the spirit of the inventive concept described herein. Therefore, it is not intended that the scope of the invention be limited to the specific embodiments illustrated and described.

What is claimed is:

1. A method performed by a gaming device comprising:
transferring a boot program from a first memory to a second memory;
loading a first program, pursuant to instructions from the boot program, from a third memory into the second memory, the first program including a decryption algorithm, the decryption algorithm using a key from the first memory to decrypt an encrypted gaming program; and
loading the gaming program from the third memory into the second memory, pursuant to instructions from the first program, the gaming program being encrypted when in the third memory, the decryption algorithm decrypting the gaming program using the key from the first memory, the second memory being accessed by a first microprocessor to carry out the game program.

2. The method of claim 1 wherein the first memory comprises a flash memory or an EEPROM.

3. The method of claim 1 wherein the second memory comprises a RAM.

4. The method of claim 1 wherein the second memory comprises a voltage supported static RAM.

5. The method of claim 1 wherein transferring the boot program from the first memory to the second memory comprises a second microprocessor controlling transferring the boot program from the first memory to the second memory, wherein loading the gaming program from the third memory into the second memory comprises the first microprocessor controlling loading the gaming program from the third memory into the second memory.

6. The method of claim 1 further comprising:
the boot program calculating a checksum of memory locations in the second memory;
the boot program comparing the checksum with a predetermined checksum; and
in case of a mismatch, transferring the boot program from the first memory to the second memory.

7. The method of claim 1 further comprising, after the first program is loaded into the second memory, the boot program performing a system reset to start the first program to load the gaming program from the third memory into the second memory.

8. The method of claim 1 wherein the first program is a start program.

9. The method of claim 1 further comprising deleting contents of the second memory if tampering with the second memory is detected.

10. The method of claim 1 wherein the first memory and second memory are located in a housing having sensors for detecting tampering with the housing, the method further comprising deleting contents of the second memory if tampering with the housing is detected.

11. The method of claim 1 wherein the third memory comprises a CD ROM.

12. The method of claim 1 wherein the first memory, second memory, and first processor are on a printed circuit board, and the third memory is off the printed circuit board.

13. The method of claim 12 wherein the printed circuit board is located in a secure housing.

14. A gaming machine for carrying out a gaming routine, the gaming machine comprising:
at least one processor for carrying out the following method:
transferring a boot program from a first memory to a second memory;
loading a first program, pursuant to instructions from the boot program, from a third memory into the second memory, the first program including a decryption algorithm, the decryption algorithm using a key from the first memory to decrypt an encrypted gaming program; and
loading the gaming program from the third memory into the second memory, pursuant to instructions from the first program, the gaming program being encrypted when in the third memory, the decryption algorithm decrypting the gaming program using the key from the first memory, the second memory being accessed by a first microprocessor to carry out the game program.

15. The machine of claim 14 wherein the first memory comprises a flash memory or an EEPROM.

16. The machine of claim 14 wherein the second memory comprises a RAM.

17. The machine of claim 16 wherein the second memory comprises a voltage supported static RAM.

18. The machine of claim 14 wherein transferring the boot program from the first memory to the second memory comprises a second microprocessor controlling transferring the boot program from the first memory to the second memory, wherein loading the gaming program from the third memory into the second memory comprises the first microprocessor controlling loading the gaming program from the third memory into the second memory.

19. The machine of claim 14 wherein the at least one processor further carries out the method comprising:
the boot program calculating a checksum of memory locations in the second memory;
the boot program comparing the checksum with a predetermined checksum; and
in case of a mismatch, transferring the boot program from the first memory to the second memory.

20. The machine of claim 14 wherein the at least one processor further carries out the method comprising:
after the first program is loaded into the second memory, the boot program performing a system reset to start the first program to load the gaming program from the third memory into the second memory.

21. The machine of claim 14 wherein the first program is a start program.

22. The machine of claim 14 further comprising a deletion circuit in communication with the second memory that deletes contents of the second memory if tampering with the second memory is detected.

23. The machine of claim 14 wherein the first memory and second memory are located in a housing having sensors for detecting tampering with the housing, the machine further a deletion circuit in communication with the second memory that deletes contents of the second memory if tampering with the housing is detected.

24. The machine of claim 14 wherein the third memory comprises a CD ROM.

25. The machine of claim 14 wherein the first memory, second memory, and first processor are on a printed circuit board, and the third memory is off the printed circuit board.

26. The machine of claim 25 wherein the printed circuit board is located in a secure housing.
